(19) United States
(12) Patent Application Publication
(10) Pub. No.: US 2007/0139647 A1
(43) Pub. Date: Jun. 21, 2007

(54) Laser-detector-grating-unit

(75) Inventor: Willem Gerard Ophey, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/561,452

(22) PCT Filed: Jun. 21, 2004
(86) PCT No.: PCT/IB04/50940

§ 371 Date: Dec. 20, 2005

(30) Foreign Application Priority Data
Jun. 24, 2003 (EP) 03101847.6

(51) Int. Cl. G01J 3/42

(52) U.S. Cl. 356/320

(57) ABSTRACT

A bar-shaped grating beam-splitter 10 is used for the generation of focus error, tracking error, forward sense and high frequency signal. The beam-splitter is made in bars (40) and is secured to wafer consisting of a plurality of detector chips (14). Securing the bar in position is preferable to securing separate grating beam-splitters individually. Individual light detector grating units are then separated from the wafer.

This invention relates to a method of manufacturing a laser detector grating unit (LDGU), a laser detector grating unit and a grating beam-splitter.

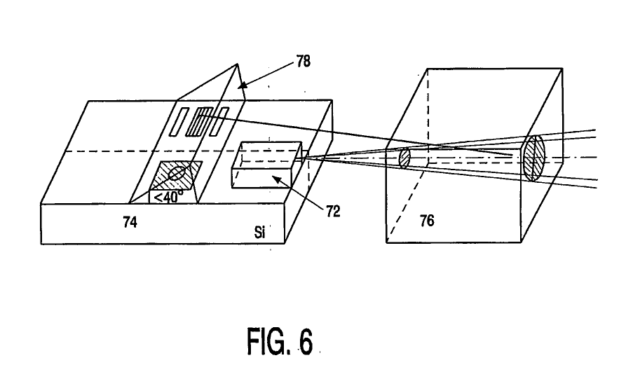

In the field of optical disks and optical recording units for optical disks it is desired to miniaturise the components forming the light path for an optical recording or reading unit. An existing method of achieving some degree of miniaturization is to glue optical opponents, including a light source in the form of a laser, onto a detector chip. Such a system is described below, with reference to FIGS. 5 and 6.

A laser detector grating unit (LDGU) with low building height is constituted as follows.

Coupling of the light beam to one side of an LDGU results in a large reduction of the building height and results in a simpler assembling of the laser.

FIG. 5 shows the concept of current LDGU (source: Philips). The position of photodiodes 70 with respect to a laser 72 and the wiring results in the diameter of this device determining the building height. Also notice that the laser 72 is perpendicular to the base plate, which results in a complicated assembly.

FIG. 6 shows embodiments in which the outgoing light beam is perpendicular with the assembly base-plate. In the FIGS. 5 and 6 the laser 72, with or without a sub-mount, is placed perpendicular with the base-plate on a photodiode chip 74. The photodiode chip 74 in its turn is placed on the base-plate (the housing). The beam-splitter grating 76 is positioned on, over or beside the photodiode/laser sub-assembly

In the embodiment of FIG. 6 a prism or mirror is attached onto the photodiode. The laser chip is mounted on the rim (edge) of the photodiode, so no sub-mount is needed.

One example of an existing beam-splitter is a semi-transparent flat mirror 78 (at an angle of 45 degrees w.r.t the beam) in which the laser light on its way to the disc is partly reflected and the light reflected by the disc is partly transmitted by the semi-mirror and passed on towards the photodiodes. A second example of a beam-splitter is a semi-reflecting beam-splitter cube.

A problem associated with the gluing of components on to a detector chip is that the components have to be placed in an exact position with only very small tolerances for the gluing procedure. In view of the difficulty of achieving small tolerances for the gluing of components, it is desired to reduce the number of components that have to be placed individually onto a detector chip.

In order to ease the problem of gluing individual components on to individual chips, as many components as possible should be positioned and glued on the detector chip early in the production process, whilst the chip is still part of a wafer comprising a plurality of chips. After positioning the components the detector chips are separated into individual detector chips.

Some components must be individually positioned on an individual detector chip, including the laser and collimator lens. It is currently the case that a beam-splitter, placed between a laser and a collimator has to be positioned individually on a detector chip. A beam-splitter is used to combine a focus-error detection, a tracking-error and a forward sense function. The above referenced document describes several of this type of beam-splitter, which all have the disadvantage that the beam-splitter must be individually positioned on the detector chip.

It is an object of the present invention to provide an LDGU with reduced production time and/or which has improved manufacturing tolerances for the assembly of an LDGU.

According to a first aspect of the invention a method of manufacturing a laser detector grating unit (LDGU) comprises:

securing a laser unit and a collimator lens to each of a plurality of photodiode chips, which photodiode chips form part of a photodiode wafer;

securing at least one grating beam-splitter strip across a plurality of said photodiode chips forming the photodiode wafer; and

separating the individual laser detector grating units from each other, by dividing the at least one grating beam-splitter strip and separating the photodiode chips.

Each LDGU preferably includes a photodiode chip, a laser unit, a collimator lens and a grating beam-splitter.

The division of the at least one beam-splitter strip and the separation of the photodiode chips is preferably done at substantially the same time, preferably by a sawing action.

To facilitate and retain the advantages of the separation of adjacent LDGUs, sides of individual grating beam-splitters split from the at least one grating beam-splitter strip do not require finishing after separation.

Advantageously, the grating beam-splitters transmit light through only front, rear and bottom faces, thus leaving the side faces (which are revealed when separated from adjacent grating beam-splitters) unused during functioning of the grating beam-splitters.

The grating beam-splitter strip is preferably substantially cuboidal. The upper and front faces are preferably substantially reflective, preferably by means of a reflective coating.

Preferably, the front face has an opening in the reflective coating of each of the grating beam-splitters to be formed from the grating beam-splitter strip. Preferably, the opening is arranged to receive light from the laser. Preferably, the opening is slightly larger than an incoming laser beam, preferably to allow reflection of the laser beam from around the opening to a forward sense photodetector.

Advantageously, the filling of the opening with the laser beam prevents the entry of unwanted light into the grating beam-splitter.

A grating structure is preferably formed on or applied to the rear face of the grating beam-splitter.

The grating-beam splitter strip is preferably secured to the photodiode base using optically transparent adhesive.

The grating beam-splitter strip preferably has planar upper, front and rear faces.

Locating the grating beam-splitter strip with respect to at least one edge of the wafer is advantageous compared to individually locating said beam-splitters.

The grating beam-splitter may extend substantially across the width of the LDGU. The side faces of the grating beam-splitter may be located at edges of the LDGU.

The LDGU may have a low building height.

According to a second aspect of the present invention a laser detector grating unit (LDGU) comprises a laser, a collimator lens, a photodetector section and a grating beam-splitter, wherein the grating beam splitter has substantially reflective upper and front faces and a grating structure on a rear face.

The front face may have an opening in a reflective coating thereof.

A rear face of the grating beam splitter preferably incorporates a holographic grating structure. The grating structure preferably has a herringbone shape, preferably comprising nestled V-shapes.

The grating structure preferably comprises a plurality of individual grating portions, preferably one for each LDGU.

The grating beam-splitter is preferably operable to split a beam into orders directed upwards and downwards from the grating structure.

The grating beam-splitter preferably has unfinished side faces, resulting from separation from at least one adjacent grating beam-splitter.

Preferably, the grating structure has a pitch equal to the pitch of elements of the photodetector section on the wafer.

According to a third aspect, the invention extends to a grating beam-splitter as described in relation to the second aspect.

All of the features described herein can be combined with any of the above aspects, in any combination.

For a better understanding of the invention and to show how the same may be brought into effect, a specific embodiment will now be described, by way of example, and with reference to the accompanying drawings, in which:

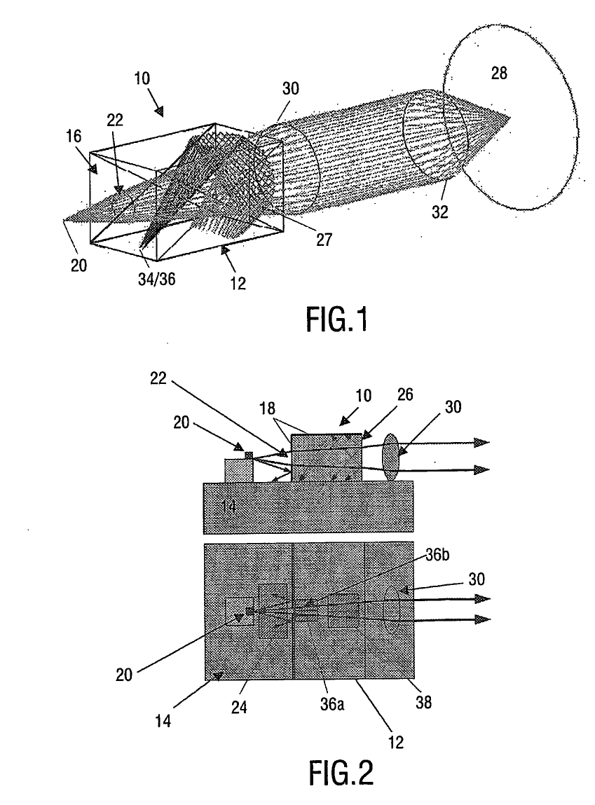

FIG. 1 is a schematic perspective ray tracing diagram showing rays of light from a laser passing through a grating beam-splitter, to a collimator lens, to an objective lens, to an optical disc and returning to the grating beam-splitter for deflection to detection points;

FIG. 2 shows side and top views of a laser detector grating unit incorporating the grating beam-splitter shown in FIG. 1;

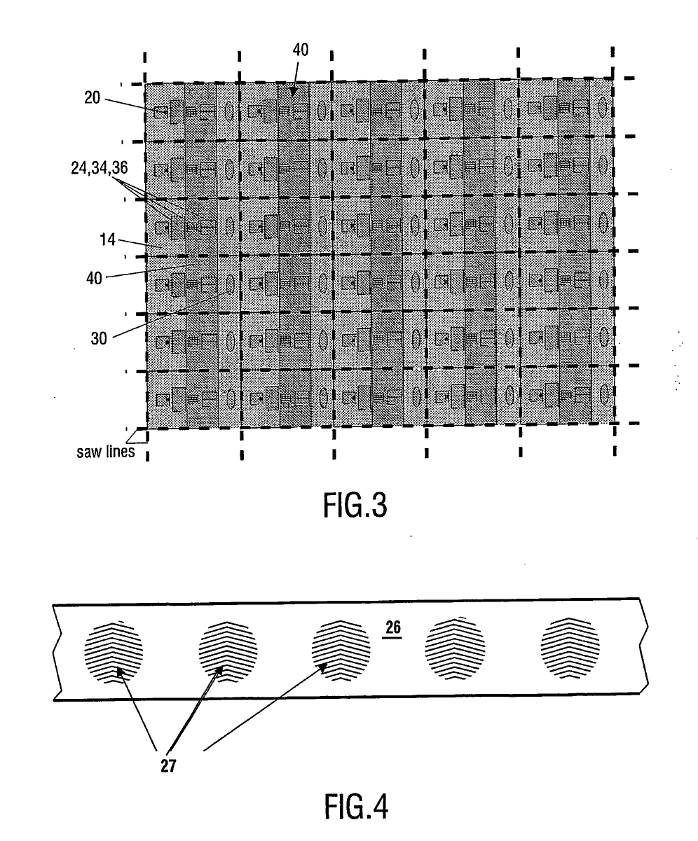

FIG. 3 shows the positioning in bar sections of the grating beam-splitters on a wafer of photodiode chips,

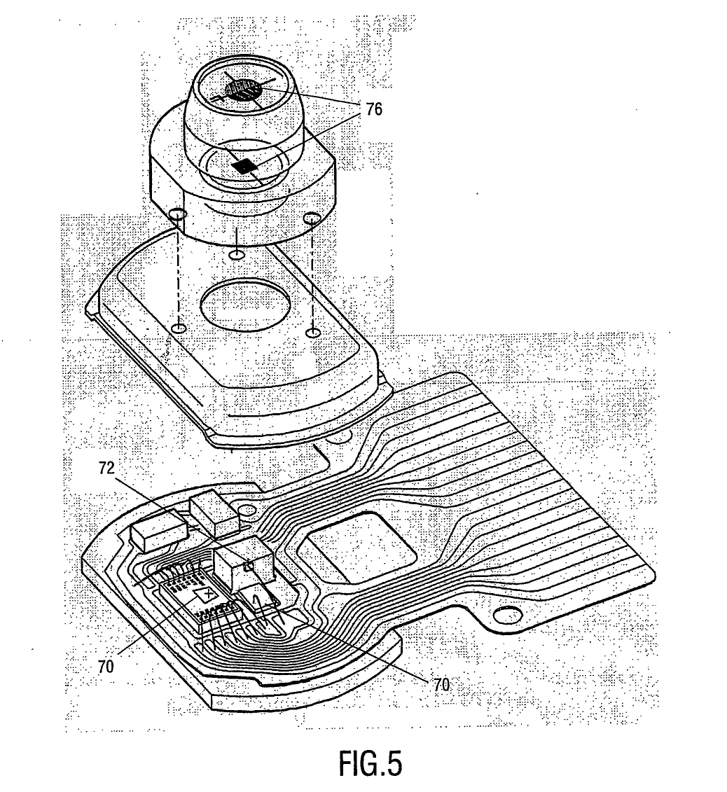

FIG. 4 is a schematic diagram of the diffraction grating structure of the grating beam-splitters;

FIG. 5 is an exploded view of a prior art laser detector grating unit (LDGU); and

FIG. 6 is a schematic view of an existing LDGU set up.

As mentioned above, optical components for an optical recording or reading unit typically include a laser, a beam-splitter, a collimator lens, and an objective lens which (except for the objective lens) are secured to a detector chip by gluing.

It is the inventive realisation of the applicant that if it is possible to combine a particular component into a strip consisting of a plurality of that particular component extending across a number of photodiode chips formed on a wafer, then the strip (and so the components) has significantly improved positioning tolerances. Joining individual beam-splitters into a bar results in a product that a person skilled in the art would typically consider to be complicated and therefore difficult to manufacture. However, the grating beam-splitter described below is relatively simple and provides considerable advantages in relation to the positioning of a bar forming a plurality of grating beam-splitters on a wafer forming a plurality of photodiode chips.

FIG. 1 shows the general design of an optical pickup. A grating beam-splitter (10) consists of a simple cuboid glass body 12, which is glued onto a photodiode chip 14 (see FIG. 2a/b).

A front surface 16 of the glass body 12 is provided with a reflective coating 18. A laser beam from a laser 20 enters the grating beam-splitter 10 through an opening 22 in the reflective coating 18. The reflective coating 18 on the front surface 16 of the cuboid glass body 12 reflects light outside the opening 22, which prevents unwanted light from entering the grating beam-splitter 10. Consequently, no stray light reaches the photodiode (described below) beneath the grating beam-splitter 10. Also, some of the light reflected from around the opening 22 on the front surface 16 of the glass body 12 falls onto a forward sense photodiode 24, which is located in front of the grating beam-splitter, as shown in FIG. 2b.

A rear surface 26 of the grating beam-splitter 10 is provided with a split herringbone shaped holographic grating structure 27, as shown in FIG. 4. The grating structure comprises nestled v-shaped elements of the structure pointing in a vertical direction. Individual grating portions are provided for each grating beam splitter 10. The pitch of the individual grating shapes on the strip equals the pitch of the photodiodes on the wafer. The beam-splitter strips have to be aligned laterally. The exact shape and period of the grating structure is calculated using a ray-tracing computer program. The shape of the grating lines is close to be hyperbolic.

The light from the laser 20 is reflected against an optical disk 28 (see FIG. 1) via the usual collimator lens 30 and objective lens 32. The light then enters the rear surface 26 of the grating beam-splitter 10. The light entering the grating beam-splitter 10 is diffracted by the diffracting grating structure 27 into two orders. The first order is diffracted upwards and is reflected by the reflective coating 18 on a top surface of the grating beam-splitter 10 and then focussed into two slightly separated spots on middle lines of two photodiode pairs 36a and 36b. The pairs of twin photodiodes 36a and 36b are used for the well known Foucault focus-error detection method. The signals from the pairs of twin photodiodes 36a/b can also be used to obtained a push-pull (PP) signal and a data (HF) signal, as is known to the skilled person.

The second order diffracted by the grating structure 27 at the rear face 26 of the grating beam-splitter 10 is directed downwards to impinge on a large twin photodiode 38 beneath the grating beam-splitter 10 to detect a PP signal and an HF signal.

FIG. 3 shows the positioning of bars 40 that comprise a plurality of grating beam-splitters 10 as described above. The bars 40 are made as follows.

A thin glass plate is provided with an array of holographic grating structures 27 (as described above) by a lithographic method. The thin glass plate is sawn into bars 40, each bar having a rear face bearing the above mentioned diffraction grating structure. A front face 16 and an upper face of the bars 40 are polished and provided with reflective coatings 18. The opening 22 in the reflective coating 18, for each of the grating beam-splitters 10 is edged into the reflective coating 18 by a simple lithographic method.

The bars 40 are positioned in place, as shown in FIG. 3 and glued onto the surface of a wafer comprising a plurality of photodiode chips 14. The bars are glued in position with an optically transparent cement. Afterwards, the individual photodiode chips 14 are separated to provide individual laser detecting grating units. The glued layer between the grating beam-splitter 10 and the photo detectors on the photodiode chip 14 avoids a total internal reflection of the diffracted orders in the grating beam-splitter 10.

The advantages provided by the method and arrangement described above are that considerable advantages are achieved in relation to the tolerances achievable in locating the beam-splitters 10. The improved tolerances provide beneficial reductions in cost also. Furthermore, the step of positioning a plurality of beam-splitters in one action (rather than one action for each beam-splitter) is advantageous, because of the reduced production time and hence reduced production cost.

1. A method of manufacturing a laser detector grating unit (LDGU) comprises:
securing a laser unit and a collimator lens to each of a plurality of photodiode chips, which photodiode chips form part of a photodiode wafer;
securing at least one grating beam-splitter strip across a plurality of said photodiode chips forming the photodiode wafer; and
separating the individual laser detector grating units from each other, by dividing the at least one grating beam-splitter strip and separating the photodiode chips.

2. A method as claimed in claim 1, in which the division of the at least one beam-splitter strip and the separation of the photodiode chips is done at substantially the same time.

3. A method as claimed in either claim 1, in which sides of individual grating beam-splitters split from the at least one grating beam-splitter strip do not require finishing after separation.

4. A method as claimed in claim 1, in which the grating beam-splitters transmit light through only front, rear and bottom faces.

5. A method as claimed in claim 1, in which the grating beam-splitter strip is substantially cuboidal.

6. A method as claimed in claim 1, in which the upper and front faces are substantially reflective.

7. A method as claimed in claim 6, in which the front face has an opening in the reflective coating of each of the grating beam-splitters to be formed from the grating beam-splitter strip.

8. A method as claimed in claim 1, in which grating structures are formed on or applied to the rear face of the grating beam-splitter.

9. A method as claimed in claim 1, in which the grating beam-splitter extends substantially across the width of the LDGU.

10. A laser detector grating unit (LDGU) comprises a laser, a collimator lens, a photodetector section and a grating beam-splitter, wherein the grating beam splitter has substantially reflective upper and front faces and a grating structure on a rear face.

11. A LDGU as claimed in claim 10, in which a rear face of the grating beam-splitter incorporates a holographic grating structure.

12. An LDGU as claimed in claim 11, in which the grating structure has a herringbone shape.

13. An LDGU as claimed in either claim 11, in which the grating structure has a pitch equal to the pitch of elements of the photodetector section on the wafer.

14. An LDGU as claimed in claim 10, in which the grating beam-splitter has unfinished side faces.

15. A grating beam-splitter as claimed in claim 10.
